(19) United States
(12) Patent Application Publication
(10) Pub. No.: US 2022/0174916 A1
(43) Pub. Date: Jun. 9, 2022

(54) ECOLOGICAL CONSERVATION SYSTEM AND METHOD FOR ARTIFICIAL COASTAL WETLAND

(71) Applicant: Yellow Sea Fisheries Research Institute, Chinese Academy of Fishery Sciences, Qingdao (CN)

(72) Inventors: Yingeng WANG, Qingdao (CN); Bin LI, Qingdao (CN); Guoqing WANG, Qingdao (CN); Yongxiang YU, Qingdao (CN); Zhongxi TIAN, Qingdao (CN); Zheng ZHANG, Qingdao (CN); Meijie LIAO, Qingdao (CN)

(21) Appl. No.: 17/532,492

(22) Filed: Nov. 22, 2021

(30) Foreign Application Priority Data
Dec. 8, 2020 (CN) 202011441275.0

(51) Int. Cl. A01K 61/59; A01K 61/10

(52) U.S. Cl. CPC A01K 61/59; A01K 61/10

(57) ABSTRACT

An ecological conservation system and method for an artificial coastal wetland are provided. The system can include a fish and shrimp ecological breeding area, an artemia breeding area and a bromine extraction and salt production area, where a water inlet channel is arranged on a side of the fish and shrimp ecological breeding area; a sedimentation and biological purification channel is arranged between the fish and shrimp ecological breeding area and the artemia breeding area; a drainage channel is arranged between the artemia breeding area and the bromine extraction and salt production area; and waterfowl habitat islands are built in the fish and shrimp ecological breeding area and the artemia breeding area.

### CROSS-REFERENCE TO RELATED APPLICATION

This application claims the benefit of the filing date of Chinese Patent Application No. 202011441275.0 filed on Dec. 8, 2020, the disclosure of which is incorporated by reference as if fully set forth herein.

### TECHNICAL FIELD

This disclosure generally relates to the field of a wetland ecosystem, and in particular to an ecological conservation system and method for an artificial coastal wetland.

### BACKGROUND OF THE INVENTION

Wetland is a transitional zone between the terrestrial ecosystem and the aquatic ecosystem, and is an ecosystem that has extremely high biological productivity and abundant biodiversity on the earth. Wetland is defined in Ramsar Convention as areas of marshland, peatland or water areas, natural or artificial, permanent or temporary, with water that is static or flowing, fresh, brackish or salt, including sea areas with a water depth of no more than 6 meters at low tide. The wetlands have huge ecological benefits and environmental functions, and are praised as “kidney of the earth”.

As habitats for birds and a wide variety of wild animals, wetlands have special importance from reserves of abundant biological diversity and water resources, conservation of ecological environment and biological diversity, and development of social economy. The coast of the Yellow Sea and the Bohai Sea is an important “post station” for the North-South migration of migratory birds along the eastern coast of China and the migration of migratory birds from East Asia to Australia, at which birds stay, wade, inhabit, feed and reproduce. In recent years, as key construction projects dependent on wetland environments such as ports, industrial parks and coastal urbanization buildings keep growing, wetlands have been sharply reduced in terms of area, and even threatened by enclosure and water cut-off

Since 2017, the illegal phenomena in wetland protection have been rectified in various regions. Especially, the illegal aquaculture in the core area and the buffer area has been reverted to restore the wetland by stages and batches in five years, so as to reduce the disturbance to wetland water pollution, biological diversity decline and bird habitats. However, under the corresponding conditions, wetlands with artificial intervention, such as aquaculture ponds and fish reed ponds, will have a great impact on wetland structures, animal and plant resources and ecological environments under unreasonable intervention. At present, numerous wetlands along the coast of the Bohai Bay have been blindly reverted. In the instance of “reversion” without “wetland restoration”, stagnant water without flowing is formed, wetlands completely die out and become salinized, and vegetation become withered; and in the instance of flood irrigation after damming, the ecosystem in wetlands becomes single and aquatic plants disappear. In the both instances, finally, the wetland function is comprehensively degraded, the abundance of biological species is sharply reduced, and no bird habitat is preserved. Therefore, the conservation method is important to an artificial wetland.

The diversity of wetland functional areas also requires the diversification of wetland protection methods. Along the coast of the Bohai Bay, haline water, brackish water and fresh water coexist. Haline and brackish water wetlands are mainly used for salt production, artemia culture or aquaculture. However, with the cut-off of water sources or blind reversion, haline and brackish water wetlands are facing the situation that no water is supplied, and biological species are sharply reduced, resulting in salinization, and an absence of aquatic plants, fish, shrimp and migration of birds.

### BRIEF SUMMARY OF THE INVENTION

In order to solve the above technical problem, the present disclosure provides an ecological conservation system and method for an artificial coastal wetland, which achieve ecological maintenance of double circulation of a wetland system and a food chain, so as to guarantee a wetland attribute and abundance and safety of a biological chain.

In order to achieve the above objective, the technical solution of the present disclosure is as follows:

the ecological conservation system for an artificial coastal wetland includes a fish and shrimp ecological breeding area, an artemia breeding area and a bromine extraction and salt production area, where a water inlet channel is arranged on a side of the fish and shrimp ecological breeding area and is used for introducing seawater or brackish water into the fish and shrimp ecological breeding area; a sedimentation and biological purification channel is arranged between the fish and shrimp ecological breeding area and the artemia breeding area and is used for conveying organic high-concentration saline water containing fish and shrimp excreta in the fish and shrimp ecological breeding area to the artemia breeding area; a drainage channel is arranged between the artemia breeding area and the bromine extraction and salt production area and is used for conveying high-concentration brine formed by long-time evaporation in the artemia breeding area to the bromine extraction and salt production area; and waterfowl habitat islands are built in the fish and shrimp ecological breeding area and the artemia breeding area.

In some embodiments, the artemia breeding area and the bromine extraction and salt production area are distributed on one side of the fish and shrimp ecological breeding area in parallel, and the sedimentation and biological purification channel is arranged between the fish and shrimp ecological breeding area, and the artemia breeding area and the bromine extraction and salt production area, and surrounds the artemia breeding area; and the water inlet channel is arranged on one side of the fish and shrimp ecological breeding area away from the artemia breeding area and the bromine extraction and salt production area.

In some embodiments, water lifting pumps are arranged on the water inlet channel, the drainage channel and the sedimentation and biological purification channel.

In some embodiments, a shallow water area and a deep water area are built around the waterfowl habitat island.

An ecological conservation method for an artificial coastal wetland uses the above mentioned ecological conservation system, and includes:

carrying out ecological culture and proliferation, maintenance and biomass regulation on fish and shrimp in the fish and shrimp ecological breeding area; carrying out culture and proliferation, maintenance and biomass regulation on artemia in the artemia breeding area, and feeding caught artemia to the fish and the shrimp in the fish and shrimp ecological breeding area; conveying high-concentration saline water carrying organic matter particles in the fish and shrimp ecological breeding area to the artemia breeding area by means of the sedimentation and biological purification channel to be utilized and consumed by the artemia; maintaining a water source guarantee of each functional area in the system, connecting the functional areas and injecting and draining water of the functional areas by the water inlet channel and the drainage channel; providing, by the waterfowl habitat island, a habitat for a migratory waterfowl, and feeding the fish and the shrimp in the fish and shrimp ecological breeding area and the artemia in the artemia breeding area to the bird; and making high-concentration brine generated by long-time evaporation in the artemia breeding area enter the bromine extraction and salt production area for bromine extraction and salt production.

In a further embodiment, from March and April in spring, an artemia egg is put into pond water in the artemia culture and proliferation area and hatches into a larva, the larva grows to an adult, and then a proliferated larva is hatched so as to reproduce and grow in cycles; probiotics, fertilizer algae paste and fermented organic matter are regularly supplemented to the artemia in the period; and a pull net is used for collecting part of living artemia from May to first ten days of September, a dip net is used for collecting the artemia egg from last ten days of September to October, and the artemia egg is caught regularly in the period.

In a further embodiment, shrimp and fish fries are put into pond water in middle ten days of May.

By means of the above technical solution, the ecological conservation system and method for an artificial coastal wetland have the follow beneficial effects:

1. A self water circulation in the several functional areas of “fish and shrimp ecological breeding area-sedimentation and biological purification channel-artemia breeding area” is formed. In this way, the ecological conservation system for a wetland with the artemia breeding as a core ensures the smooth water system through human management so as to guarantee a wetland water retention function of an artificial wetland, makes up for shortages of dry-up, salinization and wetland function degradation caused by water-free supply generated by thorough reversion of a saline-water artificial wetland, and solves a dilemma of vegetation dying, and absences of fish, shrimp and a bird habitat generated by blind reversion of the saline-water artificial wetland fundamentally. The system may achieve intercommunication of the saline water and the brackish water, and achieves zero drainage basically by full use of water resources with different salinity and by self-purification and water-saving recycling of the water resource. In a case of a common culture manner, water is drained in abundance or is drained into sea after simply utilized, such that a utilization rate of water resource is low.

2. Due to continuous evaporation of seawater in saline-alkali land of a coastal wetland and practical difficulty that water may not be fully supplemented to a wetland in an arid area, haline water is finally formed. A reason of introducing the artemia in the present disclosure is that such haline water may be used to culture and proliferate the artemia. The artemia has two major functions in the system, firstly, the artemia has a purification function, that is, the artemia feeds on organic matter accumulated due to long-term non-replacement of water and plankton of unicellular algae, copepods, cladocerans, etc.; and secondly, the artemia plays a core role in the food chain, that is, the artemia acts as an active bait for growth of the shrimp and the fish in the system, which replaces feeding of an artificial bait. Moreover, the shrimp and the fish also serve as abundant large food for the bird, which forms a circulation of the food chain in the system at a food level.

3. The ecological conservation system of the present disclosure achieves culture and proliferation of aquatic organisms of the artemia, the artemia egg, the shrimp, the fish, etc., guarantees multi-nutrition food with different types and sizes for birds, provides diversified biological baits and inhabiting and foraging places for the birds of wading birds, swimming birds, predatory birds, etc. with different types and specifications, and even guarantees sufficient food (for example, the artemia and the artemia egg) for the birds in a low temperature period, thereby achieving ecological functions of the coastal wetland to meet inhabiting, feeding and reproduction of the birds.

4. Under a manner of low-density culture and proliferation, an ecological breeding mode of “human putting and natural breeding” is achieved by improving basic productivity without feeding and using a medicine. It thus appears that culture and proliferation of the artemia is a core link, not only solves a problem of gradual increase of salinity of the pond water, but also solves a problem of excessive accumulation of the organic matter in the ecological breeding pond water, thereby establishing a new method and way for wetland reversion and ecological breeding development

### BRIEF DESCRIPTION OF THE DRAWINGS

FIG. 1 illustrates a schematic diagram of layout of an ecological conservation system for an artificial coastal wetland according to an exemplary embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

The technical solutions in the examples of the present disclosure will be clearly and completely described below with reference to the drawings in the examples of the present disclosure.

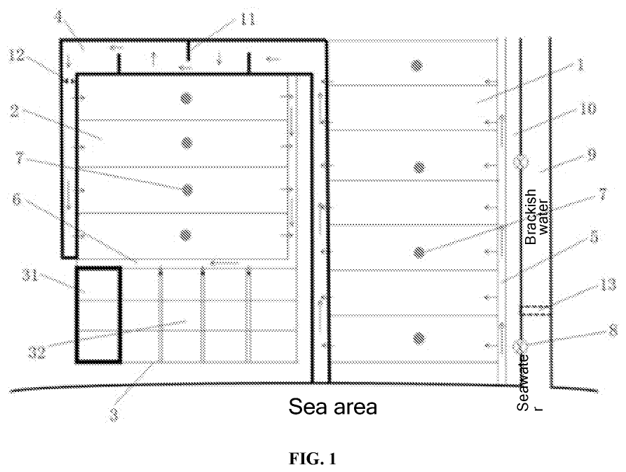

Referring to FIG. 1, the following numeral elements denote the following respective exemplary features: 1, fish and shrimp ecological breeding area; 2, artemia breeding area; 3, bromine extraction and salt production area; 31, bromine extraction area; 32, salt production area; 4, sedimentation and biological purification channel; 5, water inlet channel; 6, drainage channel; 7, waterfowl habitat island; 8, water lifting pump; 9, river; 10, road; 11, baffle plate; 12, gate; and 13, barrage.

### EXAMPLE 1

There was an aquaculture area with an area of 14,000 mu in a wetland reserve in Caofeidian District, Tangshan, China. An ecological conservation experimental system with artemia breeding as a core was formed through reversion rectification. As shown in FIG. 1, several functional areas were arranged in the system, including a fish and shrimp ecological breeding area 1, an artemia breeding area 2, and a bromine extraction and salt production area 3, where the bromine extraction and salt production area 3 was divided into a bromine extraction area 31 and a salt production area 32. The artemia breeding area 2 and the bromine extraction and salt production area 3 were distributed on one side of the fish and shrimp ecological breeding area 1 in parallel, and a sedimentation and biological purification channel 4 was arranged between the fish and shrimp ecological breeding area 1, and the artemia breeding area 2 and the bromine extraction and salt production area 3 and surrounded the artemia breeding area 2; and a water inlet channel 5 was arranged on one side of the fish and shrimp ecological breeding area 1 away from the artemia breeding area 2 and the bromine extraction and salt production area 3, and a drainage channel 6 was arranged between the artemia breeding area 2 and the bromine extraction and salt production area 3, where the artemia breeding area covered an area of 27380 mu, and the fish and shrimp ecological breeding area covered an area of 16160 mu, which were divided into a plurality of ponds with areas of 70-120 mu and other channels and roads 10 covering an area of 460 mu in order to facilitate management. 5 waterfowl habitat islands 7 were built in the fish and shrimp ecological breeding area 1, and 4 waterfowl habitat islands 7 were built in the artemia breeding area 2 so as to build a relatively independent environment and provide space and conditions for birds to inhabit, feed and reproduce. Water lifting pumps 8 were arranged on the water inlet channel 5, the drainage channel 6 and the sedimentation and biological purification channel 4. Baffle plates 11 were arranged in the sedimentation and biological purification channel 4 at intervals so as to facilitate sedimentation of large particles. A gate 12 was arranged downstream of the sedimentation and biological purification channel 4. A road 10 and a river 9 were further arranged on one side of the water inlet channel 5. A barrage 13 was arranged in the river 9 so as to separate seawater from brackish water.

Operation management of the system was completed by the following processes:

1. Culture and proliferation, maintenance and biomass regulation were carried out on an artemia in the artemia breeding area 2. In Caofeidian, Bohai Bay, according to environmental carrying capacity of the area, a time of proliferating and putting artemia eggs was March-April, a water temperature was 8-13° C., a putting density was 300 g/mu-500 g/mu, and a larva was hatched at 13-18° C. Under a condition that the water temperature rose to 15-30° C., hatching of the artemia egg reached a peak, the larva of the artemia egg growed rapidly, and growed to an adult in 2-3 weeks, the adult carried an artemia egg, and then a larva was hatched so as to reproduce and grow in cycles. In this growth stage, probiotics, fermented organic matter and fertilizer algae paste may be regularly supplemented to the artemia according to a change of water quality, so as to improve basic productivity. From May to first ten days of September, a pull net made of a polyethylene dense net was used for directly collecting part of living artemia adult bodies in the pond regularly; and from last ten days of September to October, an 80-100-mesh dip net was used for collecting the artemia egg. In this period, the bird may eat the artemia freely. Meanwhile, the artemia was caught moderately and regularly, such that on one hand, biomass of the artemia in the area was controlled; and on the other hand, caught artemia were fed to fish and shrimp in the fish and shrimp ecological breeding area 1, and a general catching amount was 50%-70% of density of existing artemia.

2. Ecological culture and proliferation, maintenance and biomass regulation were carried out on the fish and the shrimp in the fish and shrimp ecological breeding area 1. When the water temperature rose to 8-13° C. in spring, a bait organism artemia egg was put with a putting density being 300 g/mu, shrimp fries and fish fries were put when the bait organism was cultured to the middle ten days of May, shrimp fries being 1.6 cm were put with a putting density was 15,000-20,000 tails/mu, and the putting density of the fish fries was 200-300 pieces/mu. According to the number of the artemia in the pond, the artemia was collected from the artemia breeding area 2 in time to supplement a bait. Biomass of the shrimp and fish was reasonably controlled, and part of the fish and shrimp were regularly caught from the pond. In this period, an artemia body, the shrimp, fish of different specifications, etc. were used as food to be freely eaten by the bird.

3. The sedimentation and biological purification channel 4 was a communication channel between the fish and shrimp ecological breeding area 1 and the artemia breeding area 2, forming a water circulation of “fish and shrimp ecological breeding area 1-sedimentation and biological purification channel-artemia breeding area 2”. Different forms of organic matter, e.g. a large amount of particle matter, were formed in the fish and shrimp ecological breeding area 1, settled through the channel, biodegraded and purified by adding bacillus, nitrifying bacteria, etc., and then conveyed to the artemia breeding area 2 to be eaten by the artemia.

4. The water inlet channel 5 and the drainage channel 6 maintained a water source guarantee of each functional area in the system, and played the function of connecting and injecting and draining the water system of each functional area; and during a migration and return period of a migratory bird, a water level of the system was regulated and controlled (0-30 cm shallow water area) to provide a habitat for the migratory bird to forage.

5. The habitat island required by a waterfowl was built according to habits of various birds. The waterfowl habitat island 7 was built in the fish and shrimp ecological breeding area 1 with high biological bait diversity, and the surrounding shallow and deep water areas were expanded. A cross section of the waterfowl habitat island 7 was an isosceles trapezoid structure, where a height was 3 m, a length of an upper end of a trapezoid was 20 m, a length of a lower end of the trapezoid was 80 m, and a slope ratio of the island was about 1:10. On the waterfowl habitat island 7, 200-300 g of stone (stones with a diameter of 0.5-2 cm) was stacked per square meter as a home range. The shallow water area of 0-30 cm was reserved around the waterfowl habitat island 7 to provide an inhabiting and foraging place for the waterfowl. In addition, the deep water area of 3-4 m was excavated outside the shallow water area of the habitat island to provide a condition for survival of the fish and the shrimp in winter. According to a seasonal climate change and a rule of bird growth and migration, the biomass was timely regulated and controlled to provide sufficient food for the bird.

6. With evaporation of pond water in the fish and shrimp ecological breeding area 1, when the salinity rose to 40 or above, part of the pond water was drained into the sedimentation and biological purification channel for sedimentation and purification of organic matter particles, and then entered the artemia breeding area 2. Salinity of the pond water in the artemia breeding area 2 was maintained at 60-120, which was suitable for growth and reproduction of the artemia. When the salinity of the pond water was greater than 120 through long-term evaporation, a pipeline was used for draining the pond water into the bromine extraction and salt production area 3 for bromine extraction and salt production, thereby achieving ultimate utilization of water resources and achieving zero drainage in a whole culture and proliferation process.

### Ecological Effects

By means of an arrangement of each functional area in this example, content of harmful substances such as nitrite and ammonia nitrogen in the fish and shrimp ecological breeding area 1, the sedimentation and biological purification channel 4 and the artemia breeding area 2 was relatively low, which indicated that the system had a reasonable structure arrangement and a desirable purification function. The system achieved zero drainage basically by means of self-purification of the water resources, water-saving recycling and full use of the water resources with different salinity. Moreover, the artemia fed on the organic matter and plankton of unicellular algae, copepods, cladocerans, etc., and also acted as an active bait for growth of the fish and the shrimp in the system, and the fish and the shrimp provided abundant large food for the bird, thereby forming a circulation of a food chain in the system at a food level, which met requirements of wetland ecological maintenance.

In a process of ecological breeding, the artemia may be caught moderately and used as the active bait in the fish and shrimp ecological breeding area or processed into a frozen bait. Generally, a catching amount was about 50%-70% of existing density; and a general catching amount in the fish and shrimp ecological breeding area 1 was about 50% of existing density. The shrimp and the artemia eaten by the bird accounted for 20%-30% of a total amount of fry putting. In addition, fish, small miscellaneous shrimp (exopalaemon carinicauda and freshwater shrimp) and shellfish (for example, potamocorbula laevis, mactra veneriformis, ruditapes philippinarum, oncomelania, etc.) were all used for bird feeding, a total amount of which reached 10-15 kg/mu or above, and an abundant biological bait provided an excellent ecological environment for migration, inhabiting and foraging of the bird.

Survey data of a migratory bird escort action displayed that the total number of an oriental white stork in the Caofeidian wetland reserve was 700 in 2015, 1,200 in 2016, and 1,800 in 2017, and was increased to 2,500 or above in 2018, accounting for 80% or above over the world. According to incomplete statistics, the total number of an oriental white stork in this experimental system from 2015-2018 was 200, 350, 500 and 800 respectively, which accounted for about one third of the total number of the oriental white stork in the Caofeidian wetland reserve. Since the implementation of ecological breeding in 2018, an ecological effect of attracting the bird had been remarkably improved.

### Economic Benefits

In 2018, a total output of the shrimp caught from August-October was 149000 kg, a yield per mu was 41.6 kg, and an economic benefit was about 1,200-1,500 yuan/mu. A catching total yield of fresh artemia was 4.512 million kg, an average yield per mu was 940 kg, and an economic benefit was about 5000-6000 yuan/mu; and a catching total yield of the artemia egg was 31,000 kg, and an average yield per mu was 6.46 kg.

### EXAMPLE 2

In a northwest of a wetland reserve in Caofeidian District, Tangshan, about 8100 mu land was mainly used for aquaculture in an early stage. An ecological conservation experimental system with artemia breeding as a core was formed through reversion rectification. Several functional areas were arranged in the system, including a fish and shrimp ecological breeding area 1 (area A), a sedimentation and biological purification channel 4 (area B), an artemia breeding area 2 (area C), and a bromine extraction and salt production area 3, where the bromine extraction and salt production area 3 was divided into a bromine extraction area 31 and a salt production area 32. The artemia breeding area 2 and the bromine extraction and salt production area 3 were distributed on one side of the fish and shrimp ecological breeding area 1 in parallel, and the sedimentation and biological purification channel 4 was arranged between the fish and shrimp ecological breeding area 1, and the artemia breeding area 2 and the bromine extraction and salt production area 3 and surrounded the artemia breeding area 2; and a water inlet channel 5 was arranged on one side of the fish and shrimp ecological breeding area 1 away from the artemia breeding area 2 and the bromine extraction and salt production area 3, and a drainage channel 6 was located between the artemia breeding area 2 and the bromine extraction and salt production area 3.

1. The fish and shrimp ecological breeding area 1 (area A) was arranged in a northern area of a project implementation site, and covered an area of about 2,600 mu. According to a characteristic of fish and shrimp ecological culture, construction of a fish and shrimp pond with a large water surface for culture was conducive to stability of water quality of the pond and reduced human disturbance to the reserve. An embankment of a small pond (20-50 mu/pond) in the area was removed and leveled to form 3 ponds with large water surfaces and areas of about 850-900 mu.

2. The sedimentation and biological purification channel 4 (area B) was a biological bait reproduction area and covered an area of about 500 mu. A dam in this area was removed and leveled, and a pond was deepened. The pond had a depth of 3-4 m and was integrated into a semi brine transition pond (semi brine transition area) with a large water surface, so as to maintain stability of a wetland environment. Soil generated by integrating and deepening the pond was used for maintaining the dam and reinforcing and heightening the surrounding dam. Fresh high-salinity saline water and a biological bait were conveyed to the artemia breeding area through pond water evaporation, organic matter sedimentation and bait biological culture.

3. The artemia breeding area 2 (area C) was located in a south of the project implementation site, covered an area of about 5,000 mu, and was mainly used for culturing and proliferating artemia with high-concentration brine. A water inlet and drainage pipeline or an overflow pipeline was established while a pond was integrated in this area, so as to guarantee stable supply and output of water in this area, and a low dam was heightened and reinforced, so as to prevent overflow of brine in a flood period.

4. A water pump was utilized for pumping brackish water (salinity of 2-3‰) into the fish and shrimp ecological breeding area 1, and then the drainage water abundant in organic matter from the fish and shrimp ecological breeding area 1 was drained into the sedimentation and biological purification channel 4, a water source was evaporated continuously in the two functional areas, and the salinity was continuously increased to 30 or above. A drainage channel 6 with a diameter of 1 m was erected between the sedimentation and biological purification channel 4 and the artemia breeding area 2, and the evaporated brackish water was pumped into the artemia breeding area 2 from the drainage channel 6 by means of a water lifting pump 8. After that, with continuous evaporation of water, the salinity of water in the artemia breeding area 2 was continuously increased to 100 or above, and high-concentration brine of the artemia breeding area was pumped into the bromine extraction and salt production area 3 by a pipeline for bromine extraction or salt production.

5. In a case of a waterfowl habitat island 7, 3 waterfowl habitat islands 7 and 5 waterfowl habitat islands 7 were built in the fish and shrimp ecological breeding area 1 and the artemia breeding area 2 in the project implementation site respectively, a diameter of each waterfowl habitat island was 50-60 m, and a height of each waterfowl habitat island was about 3-4 m from a base. A shallow water area of about 0-30 m was reserved at a lower edge of an embankment, and was in a gentle slope with a slope ratio of about 1:10. Moreover, artificial vegetation, a false trunk, stone, a freshwater depression, etc. were arranged on the waterfowl habitat island 7, which was conducive to inhabiting and reproduction of a bird.

### Ecological Effects

By means of arrangements of the functional areas of the fish and shrimp ecological breeding area 1, the sedimentation and biological purification channel 4, the artemia breeding area 2, etc., self-purification of a water resource, water-saving recycling and full use of water resources with different salinity were achieved, thereby achieving zero drainage basically. The small pond was integrated, thereby preventing a major disadvantage of human disturbance, and being conducive to stability of water quality of the pond water. Moreover, the artemia fed on organic matter and plankton of unicellular algae, copepods, cladocerans, etc., and also acted as a bait for growth of fish and shrimp in the system, the shrimp and the fish provided abundant large food for a bird in turn, thereby forming a circulation of a food chain in the system at a food level. By means of building of the large water surface and the waterfowl habitat island 7 and a measure of human putting and natural breeding, self-purification ability of water quality in the system was promoted, diversity of species in the system for an artificial wetland was improved, and double growth of species and number of the bird was achieved.

### Economic Benefits

In an ecological proliferation area of “human putting and natural breeding”, putting density of fish fries was 300 tails/mu, putting density of penaeus vannamei and macrobrachium nipponenswas fries was 3000 tails/mu, and putting density of eriocheir sinensis was 20 tails/mu; and according to a survival rate being 65%, feeding of the bird being about 20%, retention in winter being 10% and catching being 35% of total biomass of the fish, the shrimp and the crab, it was estimated that 40 kg/mu of fish products and 20 kg/mu of shrimps and crabs may be caught every year separately, and a direct economic output value per mu was about 2,000 yuan. An actual water surface of this region covered an area of about 2,340 mu, and economic income of this region was 4.68 million yuan. A biological bait reproduction region covered an area of 500 mu, and 200 barracudas, 2,000 penaeus vannamei and 20 eriocheir sinensis were put into each mu separately. By the same reasoning, it was estimated that 10 kg/mu of fish products and 35 kg/mu of shrimps and crabs may be caught separately, and a direct economic output value per mu was about 3500 yuan; and an actual water surface area was about 450 mu, and economic income was 1.575 million yuan. To sum up, annual economic income of the ecological conservation experimental system in the wetland reserve was about 6.25 million yuan.

Along a coast of Bohai Bay, numerous wetlands had been reverted blindly, resulting in salinization of a wetland, dried-up vegetation and sharp reduction of biodiversity. Facts had proved that with artemia breeding as the core, wetland attributes and maintenance of a biological chain were guaranteed. In this system, with culture and proliferation of artemia, circulation purification and zero drainage of a wetland water system and the circulation of the food chain of multi-level nutrition may be achieved. It may be said that the artemia was a golden key to vitality of the saline-alkali wetland and was a messenger of “double circulations”. Moreover, it also showed that use of an A (fish and shrimp ecological breeding area) B (sedimentation and biological purification channel) C (artemia breeding area) system also had good ecological and economic benefits, and explored a new method and way for reversion and wetland restoration of a coastal saline-alkali wetland.

The above description of the disclosed examples enables professionals skilled in the art to achieve or use the present disclosure. Various modifications to these examples are readily apparent to professionals skilled in the art, and the general principles defined herein may be implemented in other examples without departing from the spirit or scope of the present disclosure. Therefore, the present disclosure is not limited to the examples shown herein but falls within the widest scope consistent with the principles and novel features disclosed herein.

What is claimed is:

1. An ecological conservation system for an artificial coastal wetland comprising:
a fish and shrimp ecological breeding area, an artemia breeding area and a bromine extraction and salt production area;
a water inlet channel for introducing seawater or brackish water into the fish and shrimp ecological breeding, arranged on a side of the fish and shrimp ecological breeding area and is used area;
a sedimentation and biological purification channel for conveying organic high-concentration saline water containing fish and shrimp excreta in the fish and shrimp ecological breeding area to the artemia breeding area, arranged between the fish and shrimp ecological breeding area and the artemia breeding area;
a drainage channel for conveying high-concentration brine formed by long-time evaporation in the artemia breeding area to the bromine extraction and salt production area, arranged between the artemia breeding area and the bromine extraction and salt production area; and,
a waterfowl habitat island in the fish and shrimp ecological breeding area and the artemia breeding area.

2. The ecological conservation system for an artificial coastal wetland according to claim 1, wherein the artemia breeding area and the bromine extraction and salt production area are distributed on one side of the fish and shrimp ecological breeding area in parallel, and the sedimentation and biological purification channel is arranged between the fish and shrimp ecological breeding area, and the artemia breeding area and the bromine extraction and salt production area, and surrounds the artemia breeding area; and the water inlet channel is arranged on one side of the fish and shrimp ecological breeding area away from the artemia breeding area and the bromine extraction and salt production area.

3. The ecological conservation system for an artificial coastal wetland according to claim 1 further comprising:
water lifting pumps arranged on the water inlet channel, the drainage channel and the sedimentation and biological purification channel.

4. The ecological conservation system for an artificial coastal wetland according to claim 1, further comprising:
a shallow water area and a deep water area around the waterfowl habitat island.

5. An ecological conservation method for an artificial coastal wetland, comprising:
providing a fish and shrimp ecological breeding area, an artemia breeding area and a bromine extraction and salt production area;
providing a water inlet channel, for introducing seawater or brackish water into the fish and shrimp ecological breeding, arranged on a side of the fish and shrimp ecological breeding area and is used area;
providing a sedimentation and biological purification channel, for conveying organic high-concentration saline water containing fish and shrimp excreta in the fish and shrimp ecological breeding area to the artemia breeding area, arranged between the fish and shrimp ecological breeding area and the artemia breeding area;
providing a drainage channel, for conveying high-concentration brine formed by long-time evaporation in the artemia breeding area to the bromine extraction and salt production area, arranged between the artemia breeding area and the bromine extraction and salt production area; and
providing a waterfowl habitat island in the fish and shrimp ecological breeding area and the artemia breeding area
carrying out ecological culture and proliferation, maintenance and biomass regulation on fish and shrimp in the fish and shrimp ecological breeding area;
carrying out culture and proliferation, maintenance and biomass regulation on artemia in an artemia breeding area, and feeding caught artemia to the fish and the shrimp in the fish and shrimp ecological breeding area;
conveying high-concentration saline water carrying organic matter particles in the fish and shrimp ecological breeding area to the artemia breeding area by means of a sedimentation and biological purification channel to be utilized and consumed by the artemia;
maintaining a water source guarantee of each functional area in the system, connecting the functional areas and injecting and draining water of the functional areas by the water inlet channel and the drainage channel;
providing, by the waterfowl habitat island, a habitat for a migratory waterfowl, and feeding the fish and the shrimp in the fish and shrimp ecological breeding area and the artemia in the artemia breeding area to the bird; and
making high-concentration brine generated by long-time evaporation in the artemia breeding area enter the bromine extraction and salt production area for bromine extraction and salt production.

6. The ecological conservation method for an artificial coastal wetland according to claim 5, further comprising:
putting an artemia egg into pond water in the artemia culture and proliferation area during from March and April;
supplementing, to the artemia, probiotics, fertilizer algae paste and fermented organic matter;
collecting part of living artemia, with a pull net, from May to the first ten days of September;
collecting the artemia eggs, with a dip net, from the last ten days of September to October; and
catching the artemia egg regularly.

7. The ecological conservation method for an artificial coastal wetland according to claim 5, wherein shrimp and fish fries are put into pond water in middle ten days of May.
